(19) United States
(12) Patent Application Publication
(10) Pub. No.: US 2008/0017764 A1
(43) Pub. Date: Jan. 24, 2008

(54) Swivel stand with side slot and suction cup base

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co., Ltd., Chai Wan (HK)

(21) Appl. No.: 11/824,745

(22) Filed: Jul. 2, 2007

Related U.S. Application Data
(63) Continuation-in-part of application No. 11/796,921, filed on Apr. 30, 2007.
Application No. 11/796,921 is a continuation of application No. 10/652,957, filed on Aug. 29, 2003, now Pat. No. 7,246,781.

(51) Int. Cl. A47F 5/12; A61H 15/00

(52) U.S. Cl. 248/133; 601/127

(57) ABSTRACT

A stand for supporting a vibrator/massaging device provides a swiveling and pivoting relationship through a ball joint connection between the massaging device and the base stand. The base stand comprises a suction cup bottom which enables attachment to a variety of flat surfaces. The stand has a receptacle for receiving a shaft end of the massaging device in a snug fit, and has a slot in its side wall for receiving an electrical cord for the massaging device.

### CROSS-REFERENCE TO RELATED APPLICATIONS

This application is a continuation-in-part of U.S. patent application Ser. No. 11/796,921 (referred to herein as the '921 application), filed on Apr. 27, 2007, which is a continuation of U.S. patent application Ser. No. 10/652,957 (referred to herein as the '957 application), filed on Aug. 29, 2003, and published as U.S. Patent Application Publication No. 2005/0045779 on Mar. 3, 2005. Both the '921 and '957 applications name Simon Siu Man Nan as inventor and are entitled “Swivel stand with side slot and suction cup base.” The disclosures of the '921 and '957 applications are hereby incorporated by reference in their entirety.

### BACKGROUND OF THE INVENTION

The invention relates to devices for holding and retaining massagers and vibrators for permitting hands free self-manipulation by a user. In today's society, instant gratification is a much sought-after goal. People are continually striving to devise more creative activities for deriving pleasure. The sexual device industry is fast becoming a significant market force, and the styles and varieties of sexual aids is limited only by the imagination. Vibrators and other phallic-shaped implements are a mainstay of many feminine private collections. Needless to say, for effective operation, the user must grasp the device with her hand and manually manipulate it as required. On occasion, however, it may be inconvenient or impractical to use one's hand, especially if the user has her hands engaged with a partner or is engaged in some other activity. While it may be possible to affix the vibrator or massager to a surface, the result may be dissatisfying if the rigid placement of the device does not allow for reciprocal movement with the user, and may even cause pain. It is therefore desirable to provide a capability for mounting a vibrator or massager so that it provides relative movement with respect to the point of mounting so the user may enjoy hands free manipulation.

Vibrators occasionally have power cords which can be a hindrance when mounting the device. Structures with receptacles for receiving the shaft of a vibrator normally work quite well for those that are battery operated and are cordless. For those vibrating devices which have a cord emanating from their base shaft end, however, a receptacle mounting means poses a problem. The extra space occupied by the cord prevents a snug fit, which is necessary for retention of the vibrator. While a open-bottomed receptacle might permit the cord to be guided through, it presents an inconvenience to the user in having to thread the cord through the open bottom end. A person seeking instant gratification is not likely to have the patience required to surgically guide the cord through that opening.

It would further be desirable if the means for mounting the vibrator permitted quick and easy attachment to a variety of surfaces. It would be even further desirable if the means for mounting the vibrator permitted quick and easy attachment in a variety of orientations. It would be yet further desirable if the means for mounting the vibrator was able to accommodate a power cord emanating from the vibrator and still retain the vibrator in a snug, secure mounted relationship.

### BRIEF SUMMARY OF THE INVENTION

The present invention is directed to a swivel stand device that is sized and shaped to receive a vibrating/massaging device and that allows for improved manipulation of the device without requiring use of a user's hands. The swivel stand comprises a shaft receiving receptacle pivotally mounted on to a base member through a ball and joint attachment. The receptacle is adapted for receiving and retaining the base of a vibrating/massaging device. The shaft receiving receptacle has a longitudinal slot in its side that receives the vibrator's electrical cord or the like for connecting the device to a battery or control box without interfering with the proper seating of the device's base within the receptacle. The side slot provides a convenient way to retain the cord so that it does not interfere with the snug fit of the vibrating/massaging device in the receptacle. It further provides for slight expansion of the receptacle walls to permit slightly larger diameter devices to be received in the receptacle.

The swivel stand is mounted to a suction cup base which permits attachment to a wide variety of surfaces. In operation, the swivel stand device may be temporarily attached by applying the suction cup base to a flat surface, such as a tile floor or a smooth wall. The user then inserts the base of the vibrating/massaging device into the receptacle of the swivel stand. In an embodiment, the device is inserted into the receptacle of the swivel stand by using a snap fit connection between a ball connected to the device and a cup included in the receptacle. Alternatively, the cup can be connected to the device and the ball can be included or connected to the swivel stand.

Once so inserted, the user threads the electrical cord of the vibrating/massaging device through the side slot in the receptacle. The user then may freely rotate and swivel the stand relative to the flat surface by virtue of the ball and socket joint connection between the stand and the suction cup base.

It is therefore an object of the invention to provide a stand for a vibrating/massaging device that can be attached to a wide variety of surfaces. It is a further object of the invention to provide a stand that enables the vibrating/massaging device to be manipulated into a wide variety of orientations and positions with respect to the surface engaged by the base. It is still further an object of the invention to provide a stand for a vibrating/massaging device that can accommodate an electrical or power cord disposed at the bottom of the device.

These and other objects of the present invention are realized in the preferred embodiment of the present invention, described by way of example and not by way of limitation. Additional objects, advantages and novel features of the invention will be set forth in the description that follows, and will become apparent to those skilled in the art upon examination of the following more detailed description and drawings in which like elements of the invention are similarly numbered throughout.

### BRIEF DESCRIPTION OF THE SEVERAL VIEWS OF THE DRAWINGS

FIG. 1 is a perspective view of a preferred embodiment of the present invention.

FIG. 2 is a top plan view of the device in accordance with an embodiment of the presently described invention.

FIG. 3 is a cross-sectional view in side elevation taken along lines 3-3 of FIG. 2 in accordance with an embodiment of the presently described invention.

FIG. 4 is an exploded, perspective view of the components of the device in accordance with an embodiment of the presently described invention.

FIG. 5 is a cross-sectional view in side elevation in accordance with an embodiment of the presently described invention.

FIG. 6 is an exploded, perspective view of the components of the embodiment of the device shown in FIG. 5 in accordance with an embodiment of the presently described invention.

FIG. 7 is a perspective view of the device supporting a massaging device in accordance with an embodiment of the presently described invention.

FIG. 8 is a schematic view of a cross-section of ball member and cup member in accordance with an embodiment of the presently described invention.

FIG. 9 is a schematic view of a cross-section of ball member and cup member in accordance with another embodiment of the presently described invention.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### BRIEF SUMMARY OF THE INVENTION

The present invention is directed to a swivel stand device that is sized and shaped to receive a vibrating/massaging device and that allows for improved manipulation of the device without requiring use of a user's hands. The swivel stand comprises a shaft receiving receptacle pivotally mounted on to a base member through a ball and joint attachment. The receptacle is adapted for receiving and retaining the base of a vibrating/massaging device. The shaft receiving receptacle has a longitudinal slot in its side that receives the vibrator's electrical cord or the like for connecting the device to a battery or control box without interfering with the proper seating of the device's base within the receptacle. The side slot provides a convenient way to retain the cord so that it does not interfere with the snug fit of the vibrating/massaging device in the receptacle. It further provides for slight expansion of the receptacle walls to permit slightly larger diameter devices to be received in the receptacle.

The swivel stand is mounted to a suction cup base which permits attachment to a wide variety of surfaces. In operation, the swivel stand device may be temporarily attached by applying the suction cup base to a flat surface, such as a tile floor or a smooth wall. The user then inserts the base of the vibrating/massaging device into the receptacle of the swivel stand. In an embodiment, the device is inserted into the receptacle of the swivel stand by using a snap fit connection between a ball connected to the device and a cup included in the receptacle. Alternatively, the cup can be connected to the device and the ball can be included or connected to the swivel stand.

Once so inserted, the user threads the electrical cord of the vibrating/massaging device through the side slot in the receptacle. The user then may freely rotate and swivel the stand relative to the flat surface by virtue of the ball and socket joint connection between the stand and the suction cup base.

It is therefore an object of the invention to provide a stand for a vibrating/massaging device that can be attached to a wide variety of surfaces. It is a further object of the invention to provide a stand that enables the vibrating/massaging device to be manipulated into a wide variety of orientations and positions with respect to the surface engaged by the base. It is still further an object of the invention to provide a stand for a vibrating/massaging device that can accommodate an electrical or power cord disposed at the bottom of the device.

These and other objects of the present invention are realized in the preferred embodiment of the present invention, described by way of example and not by way of limitation. Additional objects, advantages and novel features of the invention will be set forth in the description that follows, and will become apparent to those skilled in the art upon examination of the following more detailed description and drawings in which like elements of the invention are similarly numbered throughout.

### BRIEF DESCRIPTION OF THE SEVERAL VIEWS OF THE DRAWINGS

FIG. 1 is a perspective view of a preferred embodiment of the present invention.

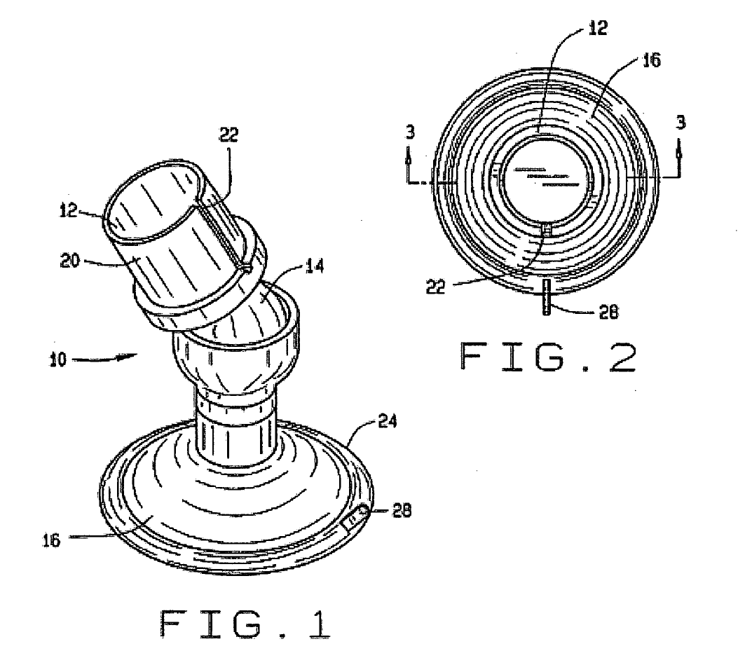

FIG. 2 is a top plan view of the device in accordance with an embodiment of the presently described invention.

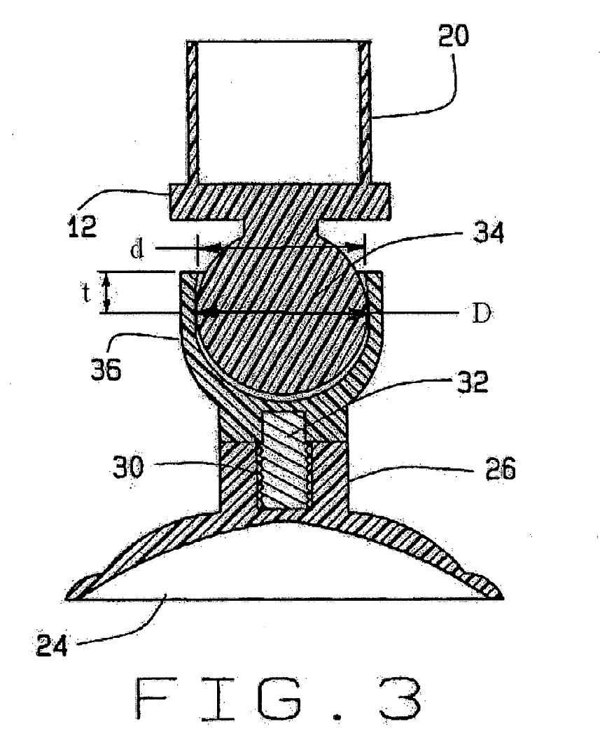

FIG. 3 is a cross-sectional view in side elevation taken along lines 3-3 of FIG. 2 in accordance with an embodiment of the presently described invention.

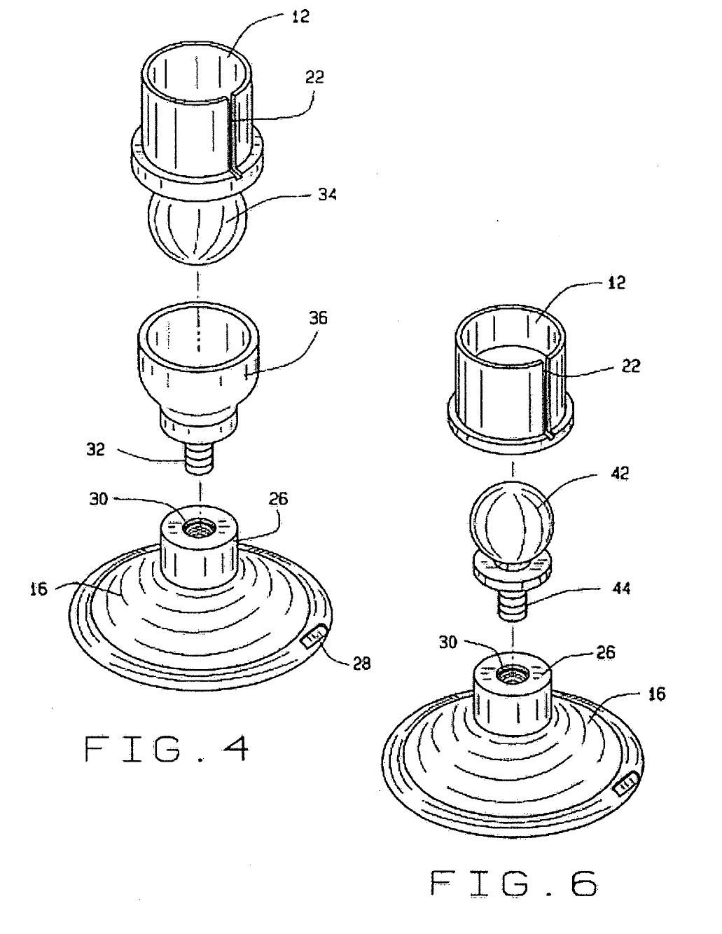

FIG. 4 is an exploded, perspective view of the components of the device in accordance with an embodiment of the presently described invention.

FIG. 5 is a cross-sectional view in side elevation in accordance with an embodiment of the presently described invention.

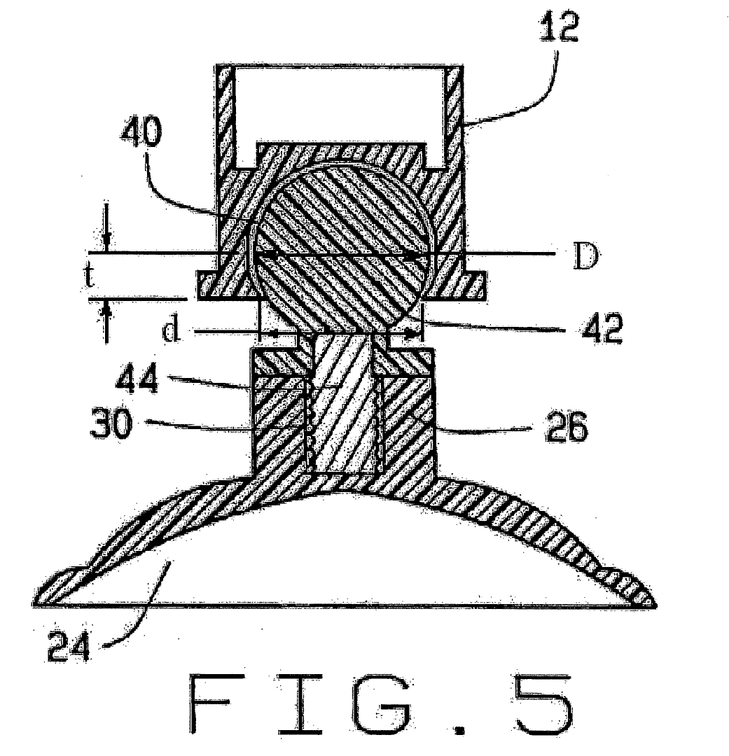

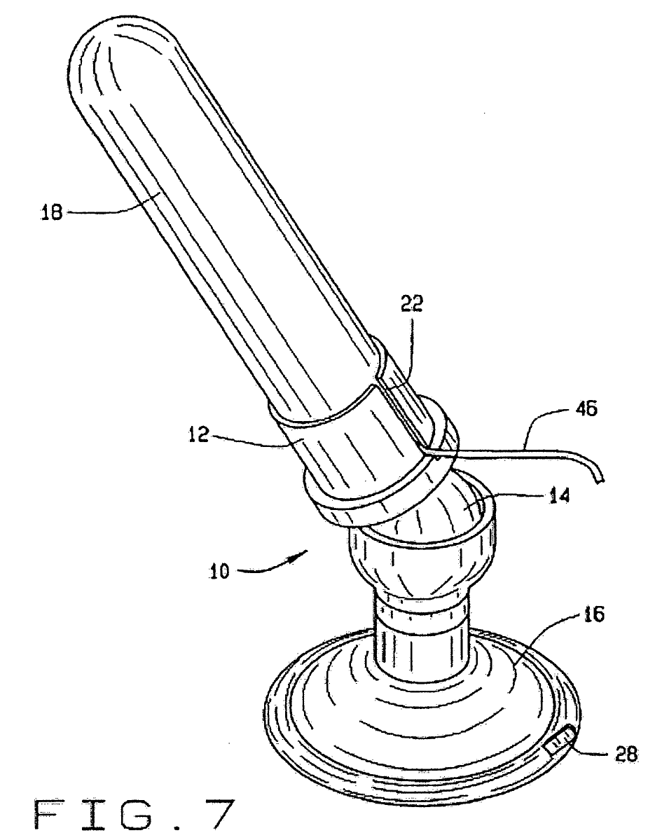

FIG. 6 is an exploded, perspective view of the components of the embodiment of the device shown in FIG. 5 in accordance with an embodiment of the presently described invention.

FIG. 7 is a perspective view of the device supporting a massaging device in accordance with an embodiment of the presently described invention.

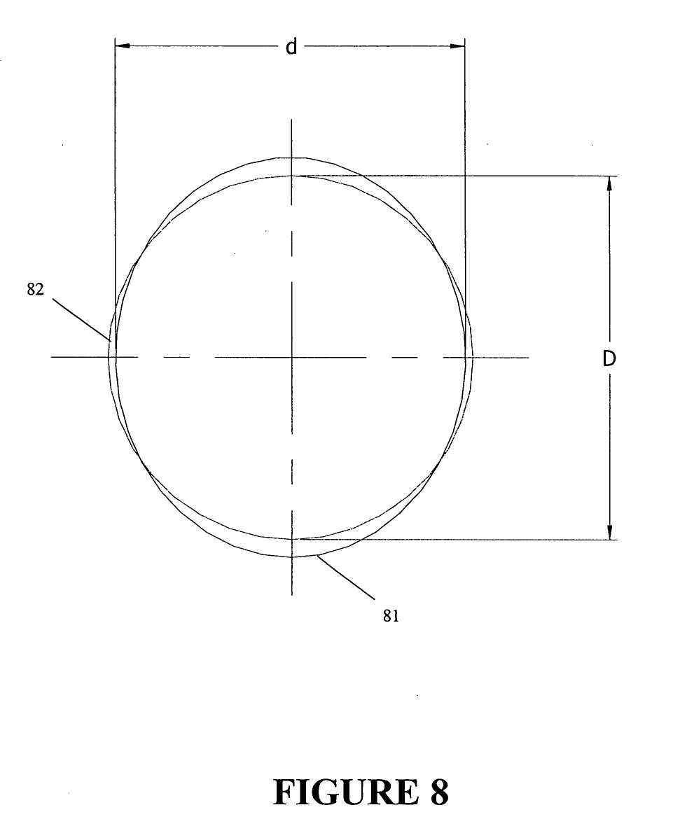

FIG. 8 is a schematic view of a cross-section of ball member and cup member in accordance with an embodiment of the presently described invention.

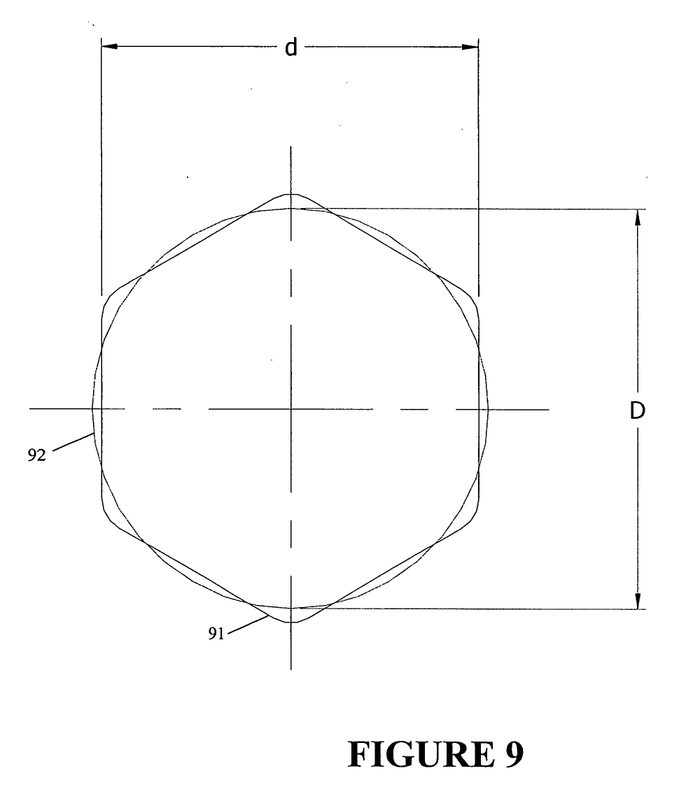

FIG. 9 is a schematic view of a cross-section of ball member and cup member in accordance with another embodiment of the presently described invention.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however,

### DETAILED DESCRIPTION OF THE INVENTION

Referring to the drawings, a preferred embodiment of the swivel stand of the present invention is illustrated and generally indicated as 10 in FIGS. 1-7. The stand comprises receiving receptacle 12, ball joint member 14, and base member 16. Receiving receptacle 12 is hollow and is adapted to receive the shaft base end of a vibrating/massaging device 18 as seen in FIG. 7. To permit expansion of side walls 20 of receiving receptacle 12, walls 20 and/or receiving receptacle 12 is preferably comprised of a plastic or other resilient material. Expansion of side walls 20 can allow a massaging device with a slightly larger diameter to be held in the receiving receptacle in a snug fit. A side slot 22 is disposed in receiving receptacle 12, and extends from a top lip thereof for a substantial distance down the side of receptacle 12 as shown in FIG. 1. Side slot 22 also permits expansion of side walls 20 to receive a massaging device with a slightly larger diameter to be held in the receiving receptacle in a snug fit.

Base 16 comprises a suction cup attachment face 24 and socket body 26. Suction cup face 24 permits attachment to a wide variety of flat surfaces, and can even be placed on a wall. A lifting tab 28 is provided on a perimeter edge of suction cup 24 to permit easy release of suction built up between the base and an engaged surface so that the device may be removed from the surface. Socket body 26 is supported on top of suction cup 24 and can be integrally formed therewith by molding or may be glued on or the like. Socket body 26 forms an internal threaded socket 30 which receives a threaded stud 32 that serves to connect ball joint 14 with base 16.

Ball joint 14 permits a swiveling and pivoting relationship between massaging device receiving receptacle 12 and base 16. One preferred embodiment is shown in FIGS. 3 and 4, and provide for a ball member 34 integrally attached to the bottom of receiving receptacle 12. Ball member 34 is dimensioned to fit in cup member 36 to establish a swiveling and pivoting relationship therebetween. Cup member 36 is provided with threaded stud 32 for attachment to threaded socket 30 of base 16.

As illustrated in FIG. 3, ball member 34 can include a diameter “D” and cup member 36 can include an inner opening of a distance “d.” In an embodiment, distance d is smaller than diameter D and, when ball member 34 is inserted into cup member 36 at least a minimum distance (indicated by distance “t”), a snap-fit connection between ball member 34 and cup member 36 is created. In an embodiment, d does not represent a diameter of a circular opening of cup member 36. That is, the cross sectional area of the opening of cup member 36 is not circular, but is of an oval or other shape, such as a polygon shape. In such an embodiment, distance d represents a distance across the non-circular opening of cup member 36. Distance d can represent the minimum, or smallest, distance across the non-circular opening of cup member 36.

In an embodiment, the minimum distance “t” can be any distance of sufficient depth into cup member 36 so that the elasticity of cup member 36 is stretched and used to hold ball member 34 in one or more of a variety of orientations when ball member 34 is inserted into cup member 36. For example, “t” can be one-third of the total distance from the opening of cup member 36 to the bottom of cup member 36. However, other distances and fractions of the distance between the opening and bottom of cup member 36 are possible and within the scope of the presently described invention.

That is, the sphere or spherical portion of ball member 34 includes diameter D whereas the opening of cup member 36 has an internal measurement d at its edge. The dimension of “d” is smaller than that of “D”, such that ball member 34 has to be forced into the cup member 36, thereby creating a snap-fit connection. There can be a significant distance “t” between the plans of “d” and “D” for providing a larger elasticity of the opening edge of cup member 36.

Another preferred embodiment is shown in FIGS. 5 and 6, and provides for a cup member 40 internally disposed in the bottom of receiving receptacle 12. Ball member 42 has a threaded stud 44 which permits engagement with threaded socket 30 of base 16.

Similar to the embodiment illustrated in FIG. 3, the sphere or spherical portion of ball member 42 can include a diameter “D” and the opening of cup member 40 can include a measurement “d” at its edge. In an embodiment, the dimension “d” is smaller than that of “D” so that ball member 42 has to be forced into the cup member 40, thereby creating a snap-fit connection. There can be a significant distance “t” between the plans of “d” and “D” for providing larger or increased elasticity of the opening edge of cup member 40. In an embodiment, d does not represent a diameter of a circular opening of cup member 40. That is, the cross sectional area of the opening of cup member 40 is not circular, but is of an oval or other shape, such as a polygon shape. In such an embodiment, distance d represents a distance across the non-circular opening of cup member 40. Distance d can represent the minimum or smallest distance across the non-circular opening of cup member 40.

In an embodiment, the minimum distance “t” can be any distance of sufficient depth into cup member 40 so that the elasticity of cup member 40 is stretched and used to hold ball member 42 in one or more of a variety of orientations when ball member 42 is inserted into cup member 40. For example, “t” can be one-third of the total distance from the opening of cup member 40 to the bottom of cup member 40. However, other distances and fractions of the distance between the opening and bottom of cup member 40 are possible and within the scope of the presently described invention.

A non-circular shape of an opening of cup member 36 and/or 40 can provide for easier deformation of the opening when ball member 34 or 42 is inserted into cup member 36 or 40. As deformation of ball members 34, 42 can be difficult to achieve when ball members 34, 42 are inserted into cup members 36, 40, making the opening of cup member 36 and/or 40 non-circular can make insertion of ball member 34 or 42 easier to achieve. In an embodiment of the presently described invention, one or more of the openings of cup members 36 and 40 is an irregular or non-circular shape. For example, the opening of cup member 36 and/or 40 can be an oval or polygon shape. In an embodiment, the term “polygon” means a closed plane figure having three or more sides. These sides can be straight sides.

FIG. 8 is a schematic view of a cross-section of ball member 34, 42 and cup member 36, 40 in accordance with an embodiment of the presently described invention. As shown in FIG. 8, cup member 36, 40 can include an oval opening 81 while ball member 34, 42 includes a circular diameter “D” 82. FIG. 9 is a schematic view of a cross-section of ball member and cup member in accordance with another embodiment of the presently described invention. As shown in FIG. 9, cup member 36, 40 can include a polygon-shaped opening 91.

When the cross-section of opening edge 81, 91 of cup member 36, 40 and/or diameter “D” 82, 92 of ball member 34, 42 is made in a non-circular shape such as oval or polygon, there are point-contacts (instead of line-contacts) between opening edge 81, 91 and ball member 34, 42. When opening edge 81, 91 and ball member 34, 42 are engaged for a snap-fit connection, edge 81, 91 and/or ball member 34, 42 can be more easily deformed when ball member 34, 42 is forced into cup member 36, 40. In other words, with a non-circular opening edge 81, 91 and/or diameter 82, 92, cup member 36, 40 can have greater elasticity for fitting ball member 34, 42 into cup member 36, 40. By having a non-circular opening 81, 91 and/or diameter 82, 92, the ball joint between ball member 34, 42 and cup member 36, 40 can provide a three-dimensional relative movement between ball member 34, 42 and cup member 36, 40 without an additional clamping mechanism.

In an embodiment, a depth of cup member 36, 40 is greater than a radius of ball member 34, 42. That is, a distance between the opening edge of cup member 36, 40 and the bottom of cup member 36, 40 is greater than half the diameter “D” of ball member 34, 42. In an embodiment, the depth of cup member 36, 40 is greater than the largest radius of ball member 34, 42.

In operation as seen in FIG. 7, the swivel stand device 10 may be temporarily attached by applying suction cup 24 of base 16 to a flat surface, such as a tile floor or a smooth wall. The user then inserts the base of the vibrating/massaging device 18 into the receiving receptacle 12. Once so inserted, the user threads the electrical cord 46 of the vibrating/massaging device 18 through threaded slot 22. The user then may freely swivel stand 10 relative to the flat surface by virtue of the ball and socket relationship between receiving receptacle 12 and base 16.

It should be understood from the foregoing that, while particular embodiments of the invention have been illustrated and described, various modifications can be made thereto, as will be apparent to those skilled in the art, without departing from the spirit and scope of the invention. Such changes and modifications are within the scope and teaching of this invention as defined in the claims appended hereto.

1. A stand for supporting a vibrating/massaging device in a swiveling and rotating relationship, said stand comprising:
a ball joint member comprising plastic;
a base member comprising a suction cup and being adapted to be connected to a support surface; and
a shaft receiving receptacle comprising plastic and directly supported on said base member through said ball joint member in a swiveling and rotating relationship,
wherein said shaft receiving receptacle has an expansive resilience and is adapted to receive a shaft end of said vibrating/massaging device in a hollow chamber of said receptacle so that said device is supported for pivotable and rotational movement with respect to said stand, said shaft end having a larger diameter than an opening of said hollow chamber.

2. The stand of claim 1 in which said ball joint member comprises a ball member pivotally received in a cup member connected to said base member, said cup member having an expansive resilience, said ball member being thereby removable from said cup member.

3. The stand of claim 2, wherein a diameter of said ball member is larger than a minimum distance across an opening edge of said cup member.

4. The stand of claim 2, wherein a cross section of an opening of said cup member is a non-circular shape.

5. The stand of claim 4, wherein said cross section is an oval.

6. The stand of claim 4, wherein said cross section is a polygon.

7. The stand of claim 2, wherein a depth of said cup member is larger than a radius of said ball member.

8. The stand of claim 1, wherein said shaft receiving receptacle defines said hollow chamber having a longitudinal slot disposed in a side wall thereof.

9. The stand of claim 8, wherein said longitudinal slot originates at a top edge of an open end of said hollow chamber and extends along a length of said hollow chamber.

10. A swivel stand comprising:
a base member; and
a receiving receptacle mounted on said base member so as to permit said receptacle to pivot with respect to said base member,
wherein said stand is capable of holding a vibrating massage device so that said device is capable of pivoting and/or rotating with respect to said base member through a ball member inserted into a cup member, said ball member having a diameter that is greater than a minimum distance across an opening of said cup member.

11. The swivel stand of claim 10, wherein a cross section of said opening is a non-circular shape.

12. The swivel stand of claim 11, wherein said cross section is an oval.

13. The swivel stand of claim 11, wherein said cross section is a polygon.

14. The swivel stand of claim 10, wherein a depth of said cup member is larger than a radius of said ball member.

15. The swivel stand of claim 10, wherein said ball member is integrally attached to said receiving receptacle.

16. The swivel stand of claim 10, wherein said receptacle includes a slot for receiving a power cord.

17. The swivel stand of claim 16, wherein said slot extends from one end of said receptacle to at least halfway to another end of said receptacle.

18. The swivel stand of claim 10, wherein said base member comprises a suction cup face and a socket body.

19. The swivel stand of claim 18, wherein said socket body and said suction cup face are integrally formed.

20. The swivel stand of claim 18, further including a threaded stud,
wherein said socket body includes a threaded socket capable of receiving said threaded stud to connect said base member with said ball member or said cup member.
